(19) United States
(12) Patent Application Publication
(10) Pub. No.: US 2012/0066233 A1
(43) Pub. Date: Mar. 15, 2012

(54) SYSTEM AND METHODS FOR MAPPING USER REVIEWED AND RATED WEBSITES TO SPECIFIC USER ACTIVITIES

(76) Inventors: Chandana Hiranjith Fonseka, Los Altos, CA (US); Sunita Sayana Lokuge, Los Altos, CA (US); Aruni Samanthi Fonseka, Los Altos, CA (US)

(21) Appl. No.: 13/227,384

(22) Filed: Sep. 7, 2011

Related U.S. Application Data
(60) Provisional application No. 61/381,954, filed on Sep. 11, 2010.

(51) Int. Cl. G06F 17/30

(52) U.S. Cl. 707/749; 707/769; 707/E17.014; 707/E17.119

(57) ABSTRACT

A computer-implemented method for helping users to find the most relevant website for a given activity includes storing, in an activity database, a plurality of activities each comprising a verb that represents a task associated with the activity, storing in the activity database addresses of a plurality of websites in association with activities respectively identified in each of the plurality of websites, receiving a query from a first user, identifying a first activity pertaining to the query by a computer server system in communication with the activity database, and returning by the computer server system, to the first user, addresses of one or more websites associated with the first activity.

### CROSS REFERENCES TO RELATED APPLICATIONS

The present application claims priority to U.S. Provisional Patent Application 61/381,954, titled “Method and system for mapping user reviewed and rated websites to specific user activities”, filed on Sep. 11, 2010, the content of which is incorporated herein by reference.

### BACKGROUND OF THE INVENTION

Over the last decade, the World Wide Web has grown exponentially with the addition of new websites on a daily basis. A user typically finds a website by typing in a set of keywords into a search engine. The search engine returns a result set spanning multiple pages. There is very little additional information on the results set page to help the user determine which of the links to actually click on. As such, the user has to click on multiple links, browse each of the websites pointed by the links, and make a determination of which website to use with limited data. Therefore, there is a strong need for a better system to help the user find the best website that contains information that the user is seeking.

In addition, when a user navigates to a webpage it is hard to know if the website is credible. Currently there is no mechanism for a user to know what other users think about a particular website that they navigate to. Therefore, there is a strong need to provide tools to allow users to gauge the credibility of a website.

### SUMMARY OF THE INVENTION

The disclosed systems and methods may significantly improve the process in which users find the most relevant website for a given activity. The disclosed systems and methods may also provide a unique method for providing meaningful context to a search query by mapping websites to specific activities.

In one aspect, the present application relates to a system for a user to find the best website for a given user activity. In this application, we define an activity as some online action that the user wants to do. Typically, an activity starts with a verb and is task oriented. Example, Buy a car, trade online, create a photo book, and share pictures. The system includes a search entry page where the user types a sentence that describes a meaningful user captured data structure which matches against a set of pre-defined user activities indexed in an activity database. Users may add to the list of user activities. Activities can be grouped into categories. Websites are indexed and mapped to a given activity which establishes a Site-to-Activity mapping. The server returns a list of websites that match against the user activity ordered by a rating system based on data captured by users of the website. This rating combined with reviews provides insights into the best website for a given activity enabling a user to decide which website to use.

Another aspect of the present application relates to a method for determining the credibility of a website. The method includes a user typing in the web URL of a website which matches against an activity database of websites that are indexed and mapped against specific user defined activities. The system returns a page that shows user ratings and reviews of that website which provides user generated data that provides insights into the credibility of a website.

Another aspect of the present application relates to a method for identifying websites that serve a specific user activity. The method includes defining a context through a user activity and mapping the website to one or more activities. The site-to-activity mapping is searchable; the results that match a given site-to-activity mapping are returned for a user-defined query.

Another aspect of the present application provides a method for a company or website to provide credible and independent customer testimonials to their customers. This method includes providing a graphical seal or link the company may embed in their website that links to a page that provides customer reviews and ratings of their website.

Another aspect of the present application provides a method for website owners to compare their website against similar websites across several attributes. This method includes providing website owners multiple views to compare how their website rates to other websites.

Another aspect of the present application provides a flexible server and presentation that may easily be created and transferred across different devices. In one implementation, the described system allows a user to determine the best website on a PC through a browser.

Another aspect of the present application provides a convenient way for a user to determine the most relevant website for a given activity using a mobile device such as a smart phone or tablet computer.

In a general aspect, the present invention relates to a computer-implemented method for helping users to find the most relevant website for a given activity. The method includes storing, in an activity database, a plurality of activities each comprising a verb that represents a task associated with the activity; storing, in the activity database, addresses of a plurality of websites in association with activities respectively identified in each of the plurality of websites; receiving a query from a first user by a computer server system in communication with the activity database; identifying a first activity pertaining to the query by the computer server system; and returning to the first user, addresses of one or more websites associated with the first activity, wherein the one or more websites are stored in the activity database.

In another general aspect, the present invention relates to a computer-implemented method for helping users to find the most relevant website for a given activity. The method includes storing, in an activity database, a plurality of activities each representing a task associated with the activity; storing, in the activity database, addresses of a plurality of websites in association with activities respectively identified in each of the plurality of websites; storing, in the activity database, a rank value relative to the first activity for each of the plurality of websites that is identified to include the first activity; receiving a query from a first user by a computer server system in communication with the activity database; identifying a first activity pertaining to the query by the computer server system; and returning to the first user, addresses of one or more websites associated with the first activity in an order based on the rank values of the one or more websites relative to the first activity, wherein the one or more websites are stored in the activity database.

In yet another general aspect, the present invention relates to a computer-implemented method for helping users to find the most relevant website for a given activity. The method includes storing, in an activity database, a plurality of activities each comprising a verb that represents a task associated with the activity; storing, in the activity database, addresses of a plurality of websites in association with activities respectively identified in each of the plurality of websites; allowing a first user to create a first website and to map the first website to a first activity; receiving a query from a second user by a computer server system in communication with the activity database; identifying the first activity pertaining to the query by the computer server system; and returning to the second user, at least the address of the first website mapped to the first activity, which allows the second user to view the first website.

Implementations of the system may include one or more of the following. Each of the plurality of activities stored in the activity database can include a phrase commencing with a verb. The phrase can include an object after the verb. The phrase can include a word about a location. The computer-implemented method can further include identifying a first set of activities pertaining to the query by a computer server system; receiving a selection of the first activity by the first user from the first set of activities; and returning by the computer server system, to the first user, addresses of one or more websites associated with the first activity, wherein the one or more websites are stored in the activity database. The computer-implemented method can further include storing, in the activity database, a rank value relative to the first activity for each of the plurality of websites that is identified to include the first activity; and returning, to the first user, addresses of the one or more websites in an order based on the rank values of the one or more websites relative to the first activity. The computer-implemented method can further include receiving, from a second user, a rank value relative to the first activity for at least one of the plurality of websites that is identified to include the first activity. The computer-implemented method can further include receiving, from a second user, a review relative to the first activity for one of the plurality of websites that is identified to include the first activity. The computer-implemented method can further include storing a credibility value about the second user in the activity database, wherein the credibility value reflects the number of reviews for the plurality of websites that the second user has reviewed for the computer server system. The computer-implemented method can further include allowing the one of the plurality of websites to display a graphical seal on a webpage at the website; and providing a web link from the graphical seal to the review by the second user about the one of the plurality of websites. The computer-implemented method can further include allowing a second user to create a first website and to map the first website to a first activity; and allowing the first user to view the first website after receiving the query from the first user. The step of identifying a first activity in the query can include identifying, in the query, one or more verbs associated with the one or more activities. The query can include a text string TS, wherein the step of identifying a first activity pertaining to the query by the computer server system can include returning the first activity stored in the activity database to the first user, wherein the first activity exactly matches TS, or the first activity includes each word in (TS-s), wherein s is one or more small words, or the first activity includes each word in (TS-s-v), wherein v is one or more verbs, or the first activity includes each word in (TS-s-v-a), wherein a is one or more adjectives and adverbs, or the first activity includes each word in (TS-s-v-a-nv), wherein v is one or more noun-verbs, or the first activity includes the largest number of words in (TS-s-v-a-nv). The query can include a first word, wherein the step of identifying a first activity pertaining to the query by the computer server system can include identifying a group of words associated with the first word; and identifying the first activity based on the association between the first activity and at least one word in the group of words. The computer-implemented method can further include grouping multiple related activities in the plurality of activities stored in the activity database in a category, wherein the multiple related activities can include the first activity; presenting the multiple activities in the category to the first user; receiving a selection of at least one of the multiple activities in the category by the first user; and returning, to the first user, addresses of one or more websites associated with the at least one of the multiple activities in the category.

### BRIEF DESCRIPTION OF THE DRAWINGS

The following drawings, which are incorporated in and from a part of the specification, illustrate embodiments of the present specification and, together with the description, serve to explain the principles of the specification.

FIG. 1 is a system block diagram including a computer server system in accordance to the present invention.

FIG. 2 is an exemplified block diagram of a computer server system in accordance to the present invention.

FIG. 3 shows an exemplary relationship diagram for the core tables in the activity database in FIG. 2.

FIG. 4 shows an exemplary relationship diagram for the word association database in the activity database in FIG. 2.

FIG. 5 shows an exemplified homepage for the computer server system in accordance to the present invention.

FIG. 6 shows an exemplified user interface for the activities page in accordance to the present invention.

FIG. 7 shows an exemplified webpage for website rankings relative to an activity in accordance to the present invention.

FIG. 8 shows an exemplified webpage for ranking websites in accordance to the present invention.

FIG. 9 shows an exemplified webpage showing the details of website activities in accordance to the present invention.

FIG. 10 shows an exemplified webpage for reviewing and rating websites in accordance to the present invention.

FIG. 11 shows an exemplified profile page in accordance to the present invention.

FIG. 12 shows an exemplified user interface for a sponsor to set up an advertisement mapped to a specific activity in accordance to the present invention.

FIG. 13 shows an exemplified user interface for an advertiser to post an advertisement in accordance to the present invention.

### DETAILED DESCRIPTION OF THE INVENTION

The present application discloses a system that enables customers to review and rate websites and map websites according to a specific user activity or need. Once these mappings are established, the disclosed system allows a user to view a ranked list of websites for a specific activity. The ranking combined with the reviews helps the user discover and decide which website to use for the particular activity.

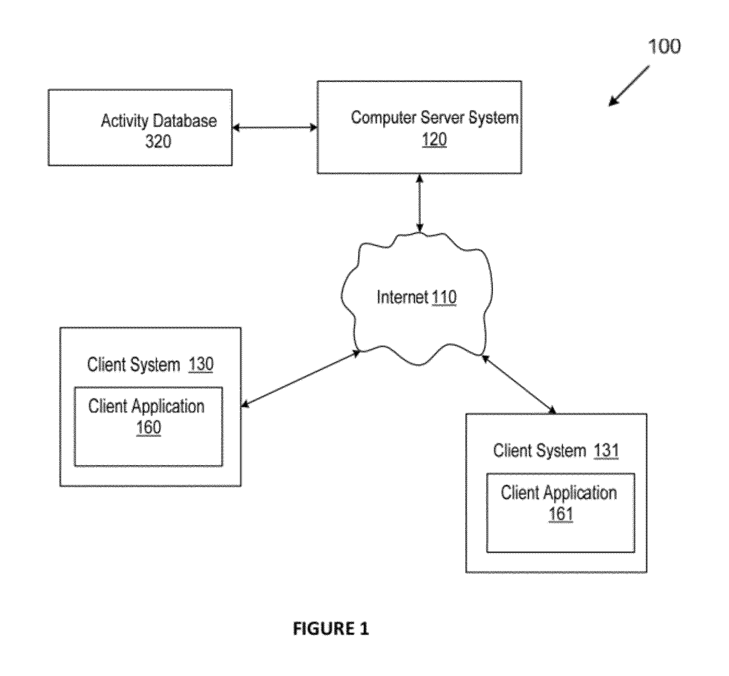

Referring to FIG. 1, a computer network system 100 includes a computer server system 120, an activity database 320, and client systems 130, 131, which are connected by the Internet 110. The client systems 130, 131 can include personal computers, smart phones, tablet computers, etc., which can be respectively installed with client applications 160, 161 such as a web browser to assist the client systems to access the Internet. Users of client applications can perform different tasks interfacing with the computer server system 120.

As described in details below, a user of the client system 130 can perform website searches with the assistance of the computer server system 120 and the activity database 320. In some cases, a second user of the client system 131 can review and rate websites, which are to be stored at the activity database 320, and which can in turn help other users to obtain more accurate searches using the computer server system 120 and the activity database 320. In some cases, a second user can be a franchise owner who creates a targeted landing page of a website mapped to one or more activities. When the first user searches for the one or more activities, the computer server system 120 can present the first user a weblink to the targeted landing page to allow the landing page to be viewed by the first user.

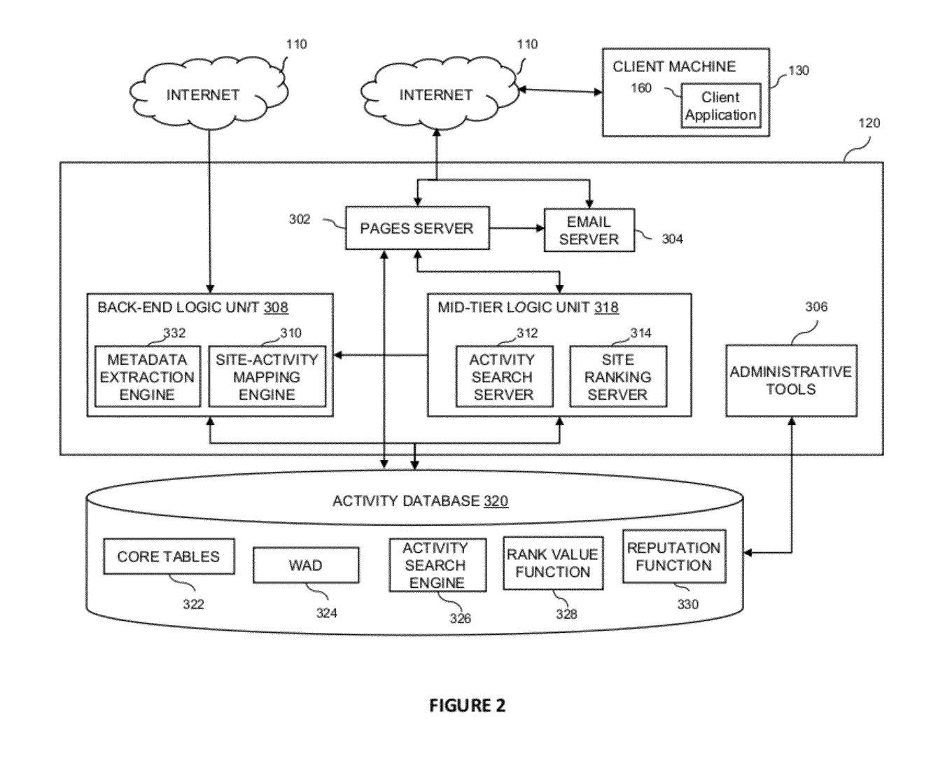

The computer server system 120, as shown in FIG. 2, includes a pages server 302, an email server 304, a mid-tier logic unit 318, and a back-end logic unit 308. The mid-tier logic unit 318 and the back-end logic unit 308 can be implemented as modules or libraries on one or more computer processors or computer servers. The pages server 302 serves as the user interface to various client applications 160 via the internet 110. The pages server 302 interacts with the mid-tier logic unit 318 and the activity database 320 to generate dynamic content for the client applications 160. The pages server 302 also interfaces with the email servers 304 to send emails to the client applications 160. The pages server 302 can be implemented via a server-side scripting language such as, for example, PHP, or Perl CGI.

The activity database 320 in communication with the computer server system 120 includes the following modules: core tables 322, a word association database (WAD) 324 comprising a dictionary and groupings of related words in the dictionary, an activity search engine 326, a rank value function 328, and a reputation function 330. These modules can be implemented in a database language such as SQL, and operate on data stored in the core tables 322 and word association database (WAD) 324. In some implementations, these modules can also operate on data from an external database or databases. Administrative tools 306 include a set of administrative functions and applications that allow system administrators to maintain and monitor the activity database 320. The core tables 322 can be implemented as entities and relations in a relational database. In another implementation, the core tables 322 can be implemented as objects in an object database.

The mid-tier logic unit 318 includes an activity search server 312 and a site ranking server 314. The activity search server 312 interfaces with an activity search engine 326 in the activity database 320 to return a set of user activities matching a user-entered search string to the pages server 302. Similarly, the website ranking server 314 interfaces with the rank value function 328 in the activity database 320 to generate ranked listings of websites for a given user activity. The mid-tier logic unit 318 can be implemented via a server-side scripting language such as, for example, PHP or Java.

The back-end logic unit 308 is used for auto-populating key data in the activity database 320. The back-end logic unit 308 includes a metadata extraction engine 332, which extracts content from the “meta” tags of websites and stores this data in the activity database 320. The back-end logic unit 308 also includes a site-activity mapping engine 310, which takes an activity as input, analyzes websites on the Internet, and returns one or more websites servicing that activity which can then be stored in the activity database 320. The back-end logic unit 308 is not accessed by the client applications 160, but rather by server-side processes which may be automated, in order to perform manipulations and modifications of data in the core tables 322 or the word association activity database (WAD) 324.

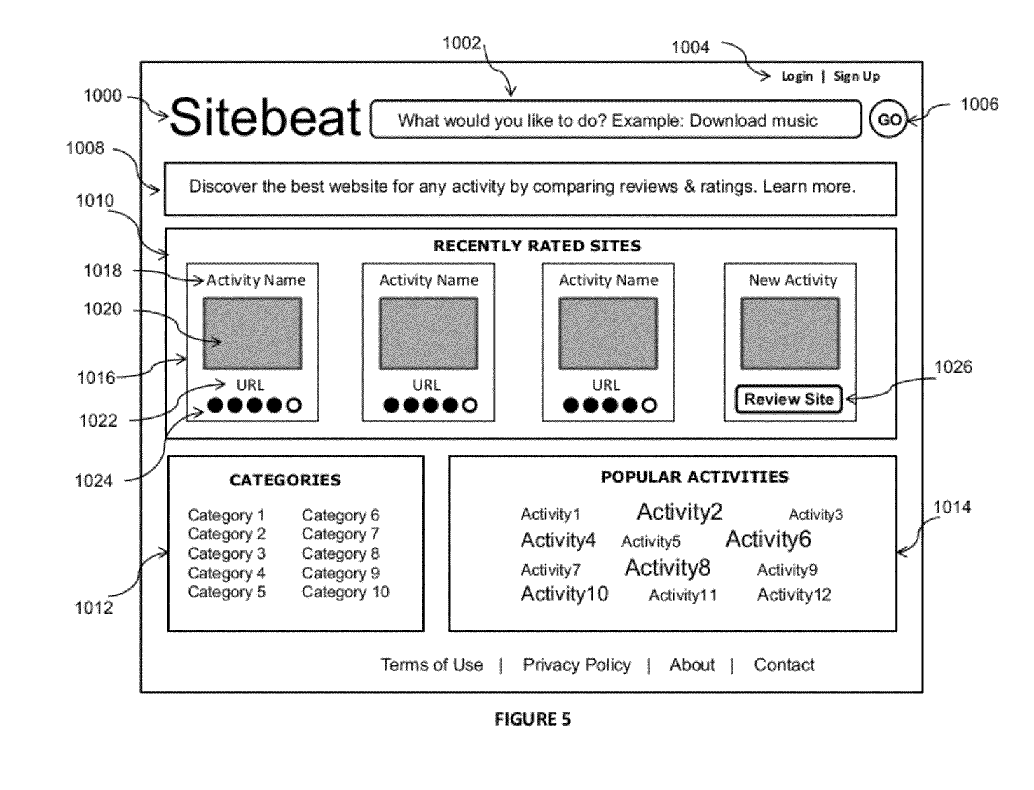

The computer server system 120 uses the activity search server 312 interfacing with the activity search engine 326 to return the set of activities from the activity table 454 that matches the non-URL text entered by the user in a header search box, for example 1002 (in FIG. 5, as discussed below).

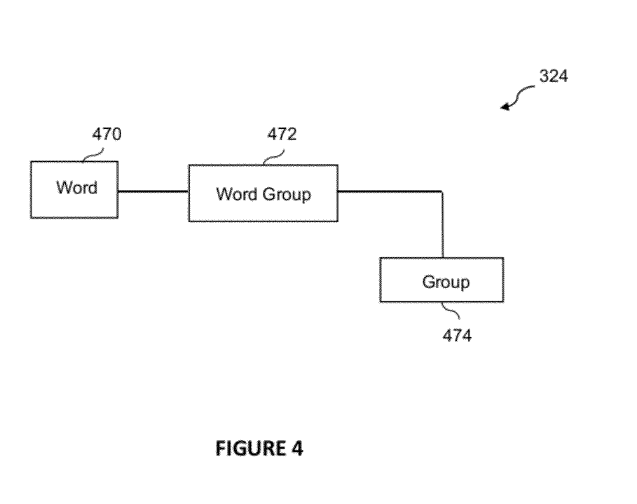

FIG. 4 shows an exemplary relationship diagram for the word association database (WAD) 324 in the activity database 320. Words 470 are tied with groups 474 via word groups 472. The resulting groups of related words are utilized by the activity search engine 326 to help return activities relevant to the user's text string submitted, for example, via the search box 1002 (FIG. 5). In an exemplary embodiment, the algorithm of the activity search engine 326 can include the following steps:

Step 0: obtain a search query comprising a text string TS from a user, where TS is a set of words;

Step 1. Return an activity that exactly matches (case-insensitive) TS (only 1 member possible)

Step 2. If not found, then

return all activities whose description includes each word (or a word from one of its related word groups) in TS

Step 3. If none found, then

return all activities whose description includes each word (or a word from one of its related word groups) in (TS-s)

Step 4. If none found, then

return all activities whose description includes each word (or a word from one of its related word groups) in (TS-s-v)

Step 5. If none found, then

return all activities whose description includes each word (or a word from one of its related word groups) in (TS-s-v-a)

Step 6. If none found, then

return all activities whose description includes each word (or a word from one of its related word groups) in (TS-s-v-a-nv)

Step 7. If none found, then

return all activities whose description includes the most number of words (or a word from one of its related word groups) in (TS-s-v-a-nv)

If none found, then
return nothing
   wherein

TS=the text string typed in by the user;

s=one or more known small words (e.g. a, an, the, of, . . . );

v=one or more known verbs;

a=one or more known adjectives and adverbs (e.g. big, great, my, . . . );

nv=one or more known noun-verbs (e.g. purchase, school . . . );

The activities that are returned can then be ordered alphabetically.

### Calculating Rank Value for a Given Website and Activity

Referring to FIG. 2, the site ranking server 314 in the mid-tier logic unit 318 invokes a rank value function 328 which returns a rank value for a given website and activity. The rank value is a numeric value, which can be used to evaluate the given website for the given activity, and rank multiple websites for the given activity, when called for at least one website and the results ordered in numeric descending order.

The rank value function algorithm can be based, for example, on one or more factors, including:
a. The weighted average of site ratings across one or more attributes of that activity. The attribute weightings could be changed to obtain a new (and possibly different) Rank Value. This allows for the fact that different users might place emphasis on different attributes.
b. The reputation of users who have provided the ratings. More weight would be given to a rating if it is given by a user with a high reputation; conversely, less weight would be given if the user has a low reputation.
c. The recency of the ratings. Older ratings would contribute less to the Rank Value, while newer ratings would contribute more.
d. The volume of ratings. Websites that have a large number of ratings would have a more reliable Rank Value, while websites with a small number would have a less reliable one.

In an exemplary embodiment of the Rank Value function, the following implementation can be used:

Rank Value(Site,Activity)=C1*RV1+(1−C1)*RV2

Where,
C1=Configurable weighting for “Overall” Attribute rating (e.g., a number between 0 and 1)
RV1=Weighted average of “Overall” Attribute ratings
RV2=Weighted average of one or more other Attribute ratings
NB. Weighted average=Sum(W(R1)*R1, W(R2)*R2, . . . , W(Rn)*Rn)/Sum(W(R1), W(R2), . . . , W(Rn)),
   where the W(Rn) function value can be based on the recency of the rating Rn, with more recent ratings getting a higher value

### Calculating User Reputation

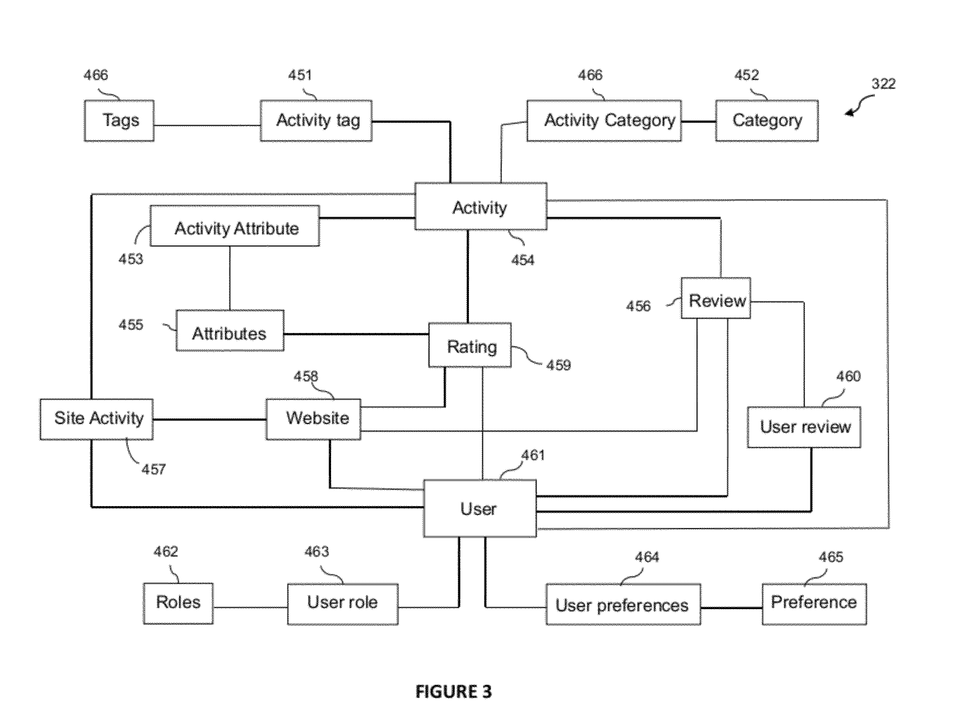

The reputation of a user is expressed as a percentage and determined by the reputation function 330 in FIG. 3 and can be based on one or more factors, including, but not limited to, the following:
1. Number of times the user's reviews have been helpful to other users (positive influence)
2. Number of times the user's reviews have NOT been helpful to other users (negative influence)

The reputation may, for example, be scoped by activity, category or overall, based on where the user has been doing their ratings and reviews. This allows users to become highly reputed in certain activities and/or categories, but not necessarily overall.

As an example for the Reputation function, the following implementation can be used:

If NHR(User,Context)<=HR(User,Context) then Reputation(User,Context)=100

Else Reputation(User,Context)=100−RF*(NHR(User,Context)−HR(User,Context))

Where

NHR(User, Context)=number of non-helpful reviews for the user in the context

HR(User, Context)=number of helpful reviews for the user in the context

RF=configurable reduction factor (how heavily to weight net non-helpful reviews)

### Quantifying User Level

The seniority, or experience level of a user on the computer server system 120 can be expressed as a number and/or a representation of that number, such as, for example:

1=Seniority Level 1 (lowest)

2=Seniority Level 2

. . .

N=Seniority Level N (highest)

N can be determined by the UserLevel function and can be based on one of more factors including, but not limited to, the one or more of the following:

a. Number of reviews posted by the user. The more reviews, the higher the UserLevel.

b. Length of review (number of characters).

c. Number of attributes rated. The more ratings, the higher the UserLevel.

d. Number of websites added.

e. Number of activities added.

f. Etc.

As an example for the UserLevel function, the following implementation can be used:

TotalPoints=C1*NumberOfReviewsPosted+C2*NumberOfLongReviewsPosted+C3*NumberOfRatingsPosted+C4*NumberOfSitesAdded+C5*NumberOfActivitiesAdded

If TotalPoints<Threshold1 then UserLevel=1

Else If TotalPoints<Threshold2 then UserLevel=2

. . .

Else If TotalPoints<ThresholdN then UserLevel=N

Else UserLevel=N+1

Where C1, C2, C3, C4, C5 are configurable constants to assign weightings to the five values. Threshold1-N is configurable thresholds to set the ranges for the applicable levels.

FIG. 3 shows an exemplary relationship diagram for the core tables 322 in the activity database 320 (FIG. 2).

A users table 461 records registered users of the computer server system 120. The users include those who directly registered the computer server system 120 as well as those users who authenticated themselves to the computer server system 120 via third-party authentication systems such as, for example, Facebook or Twitter. A user can be mapped via user roles 463 to one or more roles 462, and can have one or more preferences 465 as specified in user preferences 464. A user can add activities 454 and websites 458 to the activity database 320, and can create site-activity mappings 457.

Users can add reviews 456 for multiple site-activity combinations, and can add a rating 459 for a given website 458 for at least one attribute 455 associated with an activity 454 mapped to that website. A user can also evaluate via a user review 460 reviews done by other users.

An activity 454 can be mapped to one or more categories 452 using activity categories 466. In some embodiments, a category can include multiple levels, e.g., sub-category, sub-sub-category, etc. The activity 454 can also be tied to one or more tags 466 using activity tags 451, and to one or more attributes 455 using activity attributes 453.

Activity (454) is defined as some online action that the user wants to do. An activity usually starts with a verb, and is task-oriented; e.g., “what's the best car website?” is not an activity because it is not clear what the user wants to do. Examples of activities:

a. Buy a car

b. Open a brokerage account

c. Obtain the definition of a word

d. Dine at a restaurant in XYZ city

e. Create a photobook

f. Obtain a domain name

As shown above, some activities include object terms such as “a photobook” after the verbs such as “create”. Some activities can include location information such as state, city, addresses, zip code etc.

There is no restriction on how general or specific an activity might be. For example, (a) above is fairly general, while (d) is more specific (narrow).

For one or more activity, we define one or more attributes 455, which allow users to rate the websites which serve this activity across one or more dimensions. An attribute 455 describes some quality of the website or service. Some examples:

a. Value for money

b. Customer Service

c. Usability

d. Return Policy

e. Content quality

Attributes can be equally-weighted across an activity, or unequally so.

A category (452) is a logical grouping of activities 454, based on a context that users are likely to look for to find those activities. If a user is not sure how to frame his activity, he might be able to find it by browsing the activity lists for the appropriate category. Since an activity can be placed in more than one category, this increases the chances of the user finding their desired activity regardless of which category they browse in.

A website (458) at a web URL can support one or more activities. The computer server system 120 supports top-level urls (e.g.: www.xyz.com), sub-urls (e.g.; www.xyz.com/abc), non-standard urls (e.g.: abc.xyz.com), or any other valid (readable) web location.

Rating (459) refers to numeric evaluation of an attribute by a user for a given website S and activity N. At least one attribute A has some fixed granularity G(A). G=2 is the simplest granularity and equates to thumbs-up/down or like/dislike. G=10 allows for much more detail in opinion. The rating R(S,N,A) is simply a value between 1 and G(A). For example, the value of G can be initially chosen 5.

A review (456) is a written evaluation of a website 458, in the context of exactly one activity. This implies that a website servicing multiple activities can have reviews written for at least one of those needs. This allows users to determine whether the website 458 is suitable for their specific activity, even though it cannot be so for other needs it services.

The rank value for a given website 458 and activity 454 is a numeric value, which can be used to (a) evaluate the given website for the given activity 454, and (b) rank multiple websites for the given activity 454, when calculated for at least one website and the results ordered in numeric descending order. The value range normally corresponds to the rating range, e.g., a value between 1 and G(A) where G(A) is the granularity of at least one attribute rating. In an alternative embodiment, the Rank Value range could be independent of the rating granularity.

Reputation is a numeric value, expressed for example as a percentage, assigned to a user of the computer server system 120 reflecting the value placed on that user's opinions. Reputation can be used to help calculate Rank Value. It can also be used to provide certain benefits to the user, where the value of the benefits increases as the user's reputation increases. In an alternate embodiment the reputation could be an absolute value instead of a percentage.

The disclosed invention systems can be configured, designed, and/or operable to provide various different types of operations, functionalities, and/or features generally relating to the examples described above. Further, many of the various operations, functionalities, and/or features of the disclosed system disclosed herein can provide can enable or provide different types of advantages and/or benefits to different entities interacting with the disclosed system. For example, the disclosed system can be configured, designed, and/or operable to provide various different types of operations, functionalities, and/or features as follows:

Decide which Website to Use for a Particular Activity

User visits the home page and types a specific activity with the goal of deciding which website is best suited for his activity. The system returns a list of websites based on a ranking algorithm. The ranking algorithm takes into account user ratings of the websites and other criteria specified later in this document. In addition to the list view (default view), the user can switch to a grid view or ratings view to compare different websites. Users can get more detail such as reading one or more the reviews of what users have said about this particular website by clicking on the link to drill down.

### Enable User to See Reviews and Ratings for a Particular Website

User visits the homepage and types a specific web URL. The system returns a page that shows detailed reviews and ratings by other users for that particular website and activity. If the website has multiple activities, the user can select one activity.

### Enable User to See a List of Activities for any Website

User visits the homepage and types a specific web URL. If the website has multiple activities mapped, the user can see the full breadth of services offered by the website. User can tell which services are rated better than others.

### Enable User to Review a Given Website for a Given Activity

User can submit a comprehensive review and rating for a particular website. This is integral to the system and forms the basis for users deciding which website to use for their particular activity. These ratings and reviews continuously improve the overall knowledge base of the system. The user can have the option to rate at least one website against multiple attributes. The system has a flexible and scalable attribute system, where at least one activity can have a unique set of attributes.

### Enable User to Add a New Activity

User can add a new activity to the knowledge base and map it to a website. The user can decide to rate and review at the same time or at different times. This provides flexibility in how the knowledge base of the system evolves. As such, the system may have websites that are not ranked as of yet, but are mapped to an activity which by itself enables a (1) user to see websites for a particular activity and (2) user to see activities for a particular website.

### Enable Companies to Provide Unbiased Testimonials

A company or owner of a website may get a graphic seal that they place prominently on their website. This graphic links back to a page that provides detailed ratings and reviews of their website. These ratings and reviewed are unbiased since they are on a different website from their own and are not mediated or screened in any way.

Enable Companies to Measure their Websites Relative to Peers

A company or website owner may measure their websites relative to other websites that serve the same activity(s). They may (1) Find out who their competition is and what they are doing (market research) and (2) Get detailed, unbiased user feedback on different aspects (attributes) of their website (e.g. ease of use, content, reliability, etc) which may be used to help make their websites better. Additionally, for a fee, tailored reports can be provided to companies that provide summaries that help them assess how well they are doing.

Enable Companies to Know which Attributes are Most Important to Users for a Given Activity

We may allow users to indicate their preference (weighting) of attributes for a given activity; for example, a user might give “customer service” 80% of the total weighting of one or more the attributes for “book a hotel”. By aggregating this data we may say which attribute is the most important for the activity and to what extent. This data may also be valuable for companies that are servicing that activity and could provide further revenue for the computer server system 120.

### Enable Highly Targeted Advertisements/Sponsorships

Companies may buy sponsorships on pages that are highly targeted because we know the exact user activity. For example, the page displays the list of websites that map to “Buy a car” or “Find a hotel” are very specific with regard to the user intention. As such, sponsors may find the offering very attractive, which provides a very compelling revenue model.

### Enable Franchising of Highly Targeted Websites

Individual experts may come to the computer server system 120 and purchase a solution that enables them to set up a highly targeted “start page” or landing page for any activity they are passionate about. This creates an innovative revenue stream both through a rev share as well as through the sale of these targeted landing pages. For example, an expert in weight loss, may come to the computer server system 120 and create a page that they would own around weight loss. The computer server system 120 provides the full infrastructure to set up the page and the modules around weight loss. The user then goes and sets up relevant websites, markets the page to generate traffic and develops reviews and ratings for these websites. At least one incentive for the user is sponsorship revenue.

At a high level, the computer server system distinguish from the conventional systems in that (1) The query is associated with a unique user activity from among a database of user activities stored on our servers; and (2) At least one website is mapped to one or more user activities.

Use examples of the disclosed system are described below. One or more users use computer devices to access the computer server system 120. Users who are seeking information typically enter a query in the form of a user activity, which is mapped to the user activities in the activity database 320 (FIG. 2). If the query results in a unique match, the user is presented with a list of websites that are mapped to this particular activity. At least one website includes user reviews and ratings that form the genesis for the user deciding which website to use for this activity.

### Homepage Features and User Experience

An exemplified home page is shown above in FIG. 5. The features and components of the home page are described below.

The header can include the following:

The logo 1000 (e.g. “Sitebeat”) can be clicked to bring the user back to the home page. The search box 1002 is the primary field for user input and contains a message inside the box that prompts the user to enter an activity. The message inside the search box reads: “What would you like to do, Example download music?” In one embodiment, the user may enter an activity such as download music or trade stocks. When the user clicks the GO button 1006, the user is taken to a page that displays a ranked list of websites that match that activity. In another embodiment, the user may enter a website URL. In this case the user may be taken to a page that displays activities that are mapped to this website, as shown in FIG. 5. In another embodiment, the user may enter any text. In this case the system passes the text back to the activity search server 312 which interfaces with the activity search engine 326 and displays back in the browser a list of activities most closely matching the entered text.

Login & Sign Up 1004 takes the user to the login screen and the sign up screen respectively.

The recently rated websites module 1010 displays the most recently rated and reviewed websites. A website within this module can include: activity name 1018—displays the activity name for which this website is reviewed for (e.g. Download music, trade stocks, buy a car, rent a movie, etc.); thumbnail image of website 1020—displays thumbnail image of the website; URL 1022—displays the URL of the website; and rating 1024—displays the rating of the website.

Popular activities allow a user to browser the most popular user activities 1014. For example, the top 30 user activities are surfaced based on the popular activities algorithm described below:

Popular activities can be determined by the following steps, executed, for example, by the mid-tier logic unit 318:
1. Get the 30 activities with the most reviews from the list of featured activities
2. Split these 30 activities into 2 groups: the top 15 and the next 15. Divide at least one group into 3 subgroups of 5 activities at least one based on the number of reviews. Thus we have 6 groups of 5 reviews at least one.
3. Assign font sizes of 12, 14, 16, 18, 20 and 22 pixels respectively to the groups, with the 12-pixel font being assigned to the group with the least number of reviews (least popular) and the 22-pixel font being assigned to the group with the most number of reviews (most popular)
4. Randomly order at least one group of 15 activities
5. Print out the 30 activities in 10 rows of 3, alternately selecting from the groups. This may result in a “cloud” of activities which is visually balanced and has a random appearance.

The homepage displays a list of categories 1012. The categories are managed with an admin tool, and may change over time. User activities are grouped by category. Clicking on a category name takes the user to a category browser that displays a list of user activities. From the category browser the user may click on a specific activity to view websites mapped to this activity.

Furthermore, a toolbar is a utility that may be downloaded from website of the computer server system 120 (e.g. at Sitebeat.com) and added as a toolbar to the browser. At least one purpose of the toolbar is to provide the user a convenient way to add new websites and to review/rate them.

### Activities Page User Experience and Features

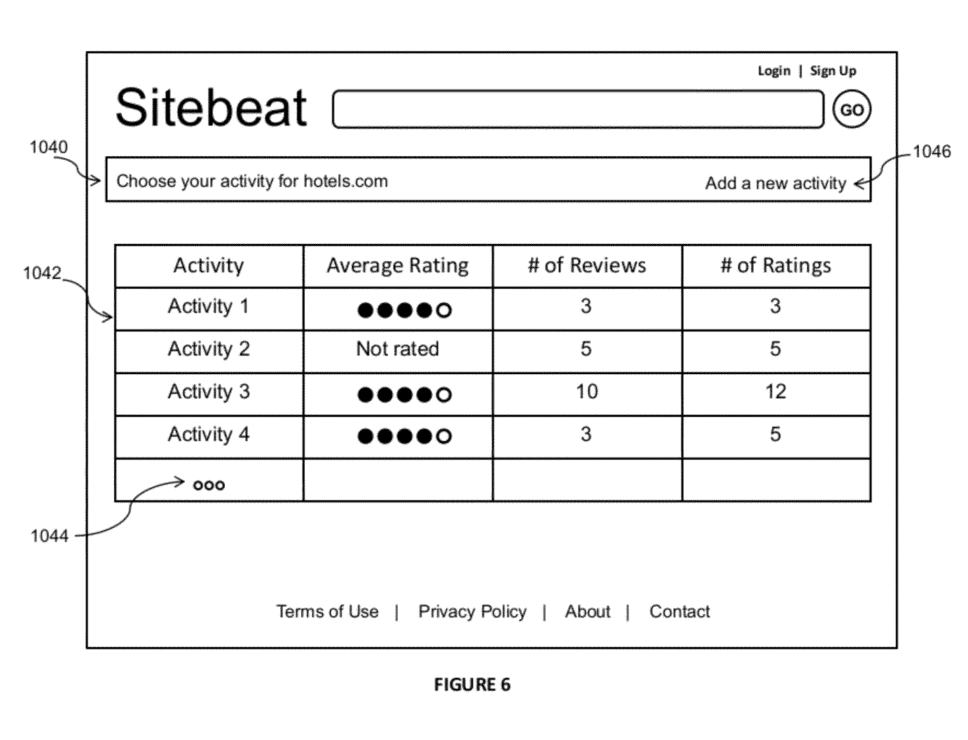

An exemplified user interface for the activities page is shown above in FIG. 6. The features and components of this page are described below:

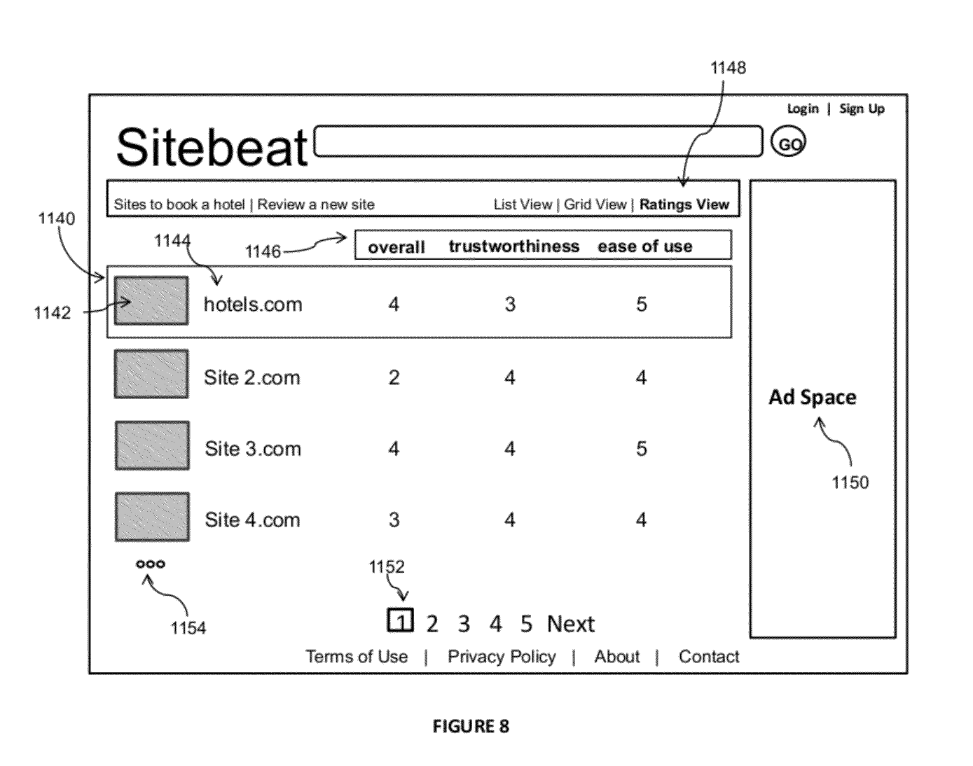

Title bar—the title bar 1040 has a message that indicates that the query the user entered matched on multiple activities. If the website happens to have only one activity mapped against it, then the user may be taken directly to the Site Ranking Page (shown in FIG. 8).

Add a new activity—this link 1046 enables the user to add a new activity and map it to this website. Clicking on this link takes the user to the review screen with website defaulted to the current website. The user may add rate this website for the new activity and rank it across multiple attributes.

Summary view—the summary tabular view 1042 displays data that helps the user decide which activities a given website enables and for at least one activity displays the average rating, # of reviews and # ratings. The average rating is calculated based on the ratings across at least one attribute for that particular activity

More activities—the tabular view is scalable as shown 1044. For websites that enable many activities this list may be very long. For scalability purposes this page paginates after 20 items on the page. The pagination model 1052 is similar to the model on one or more other pages that may require pagination.

### Site Rankings for Activity Page User Experience

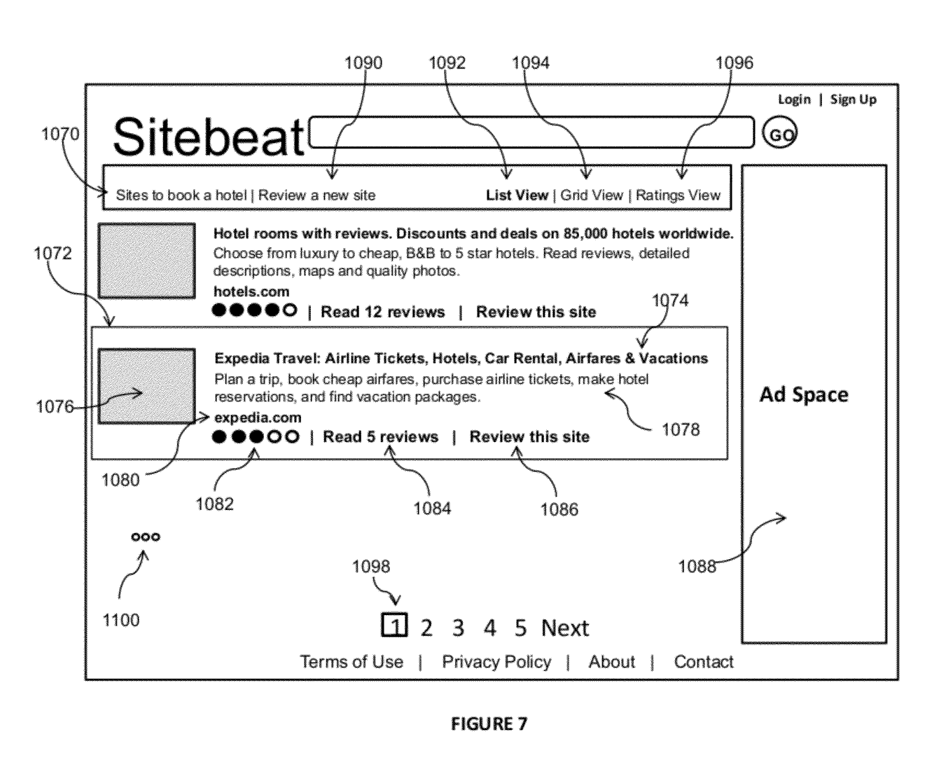

The website rankings for activity page are returned when the search query resolves to an exact match. Essentially, a unique activity has been identified. A webpage for site rankings for activity is shown in FIG. 7. The features and components of this page are described below:

A secondary header can go across most of the pages of the website. It is similar to the header on the homepage and can include: a smaller logo, a search box and a go button. A login link is displayed, if user has not logged in. User id and logout are displayed if logged in (similar to homepage).

A title bar 1070 contains the following: Activity name—a label that captures the activity name. In this example the activity name is “Sites to book a hotel”. Review a new website—the link to review a new website 1090 takes the user to review page with the activity defaulted in the system to current activity. Since the activity is known, the user is presented with a screen to enter the URL, review and rating. List View—the list view 1092 is the default view and is shown in FIG. 4. This view displays multiple websites one below the other as shown. The wireframe displays 2 websites—the list may grow 1100 to a current default of 20 websites. This default may be changed easily—so for example, by changing a parameter in the database, we may choose to display 50 websites on this page instead of 20. If there are more items than the default, the list paginates 1098.

The module 1072 that displays data about a website contains the following information: A mini graphic 1076 of the website. Clicking on this takes the user to the website opened in a separate window. The title for the website 1074 is pulled directly from the meta data of the website. Clicking on this takes the user to the website opened in a separate window; A summary description 1078 pulled directly from the meta data of the website; The URL of the website 1080. A graphical summary 1082 of the rating calculated based on the rating algorithm; The number of reviews 1084 for the website; Review this website—link to review this website 1086 that takes the user to review page.

A link 1094 can be clicked to switch to grid view. The grid view provides a quick and easy way to select a website for any activity as it displays many more websites that just the list view. A link 1096 can be clicked to switch to ratings view 1096. The ratings view is a more advanced view that enables the user to make quantitative comparisons between different websites. Sponsored advertisements can be displayed on the right column of the page 1088. This component may enable sponsors to display advertisements. Advertisements may be served through multiple mechanisms as described in the advertisement features that support the business model.

### Site Ranking Page

FIG. 8 shows an exemplified webpage for ranking websites in accordance to the present invention. The ratings view is an advanced user view and provides an easy way to compare websites across multiple attributes. The view displays modules for at least one website 1140 that include ratings data. Four websites are rated. A view scales 1154 to display multiple rows of websites. The current default is set to 20. This may easily be changed through a parameter in the database. If there are more than 20 websites in this view, it paginates 1152 similar to the other views.

A row 1140 can include the following: a thumbnail 1142 and a URL 1144 of the website. The attribute row 1146 can vary based on the particular activity and displays the attributes that apply to this activity. In this example, there are 3 attributes mapped to this activity: (1) Overall (2) Trustworthiness and (3) East of use. In a different example activity, there may be additional attributes such as return policy, which provide the user additional information to make a decision. This variable attribute schema based on the activity provides a flexible and powerful method to further evaluate which website the user may use. If the website is not rated or if the website is not rated for a particular attribute, display the words “note rated”. Sponsored advertisements are displayed on the right column of the page 1150. This component may enable sponsors to display advertisements. Advertisements can be served through multiple mechanisms as described in the advertisement features that support the business model.

### Site-Activity Detail Page

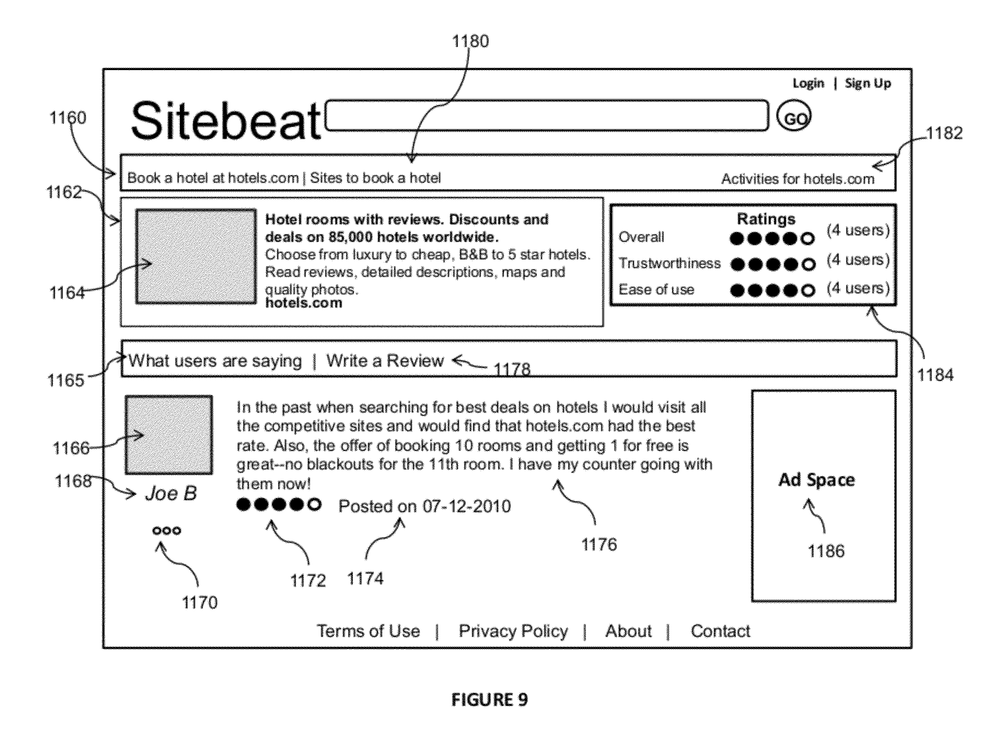

The website detail page shown below, displays detailed information pertaining to a given website satisfying a single activity. FIG. 9 shows an exemplified webpage showing the details of website activities ranking websites in accordance to the present invention. A page title 1160 describes the activity and the website. In this example, the title is “Book a hotel at hotels.com”. The title bar also provides a link 1180 to provide access to other websites to book a hotel. On the far right of the title bar is a link 1182 that displays other activities that are enabled by this particular website. A thumbnail and description of website 1162 are similar to those in the ranking page. A module 1184 shows the summary rating across one or more the attributes that apply to this particular website. In this example, it shows three attributes (1) Overall (2) Trustworthiness and (3) Ease of use. For a different activity, these attributes may defer. A review title bar 1165 provides a header to the reviews that apply to this particular website. In the title bar is a link 1178 to write a review. Clicking on this link takes the user to the review screen.

The review of the website can includes:

Profile picture—the profile picture 1166 is a picture that the user has directly uploaded to the computer server system 120 or a picture we have pulled from a social networking website like Facebook.

User ID—the user ID below the picture 1168 is the user's first name and last initial.

Review—the review 1176 is the actual review the user entered via the review webpages at the website.

Rating—the rating 1172 is a graphical summary of the rating for the website.

Date posted—the date posted 1174 displays the date the review was posted on the computer server system 120.

Sponsored advertisements are displayed on the right column of the page 1186. This component may enable sponsors to display advertisements. Advertisements may be served through multiple mechanisms as described in the advertisement features that support the business model.

### Review and Rater Page

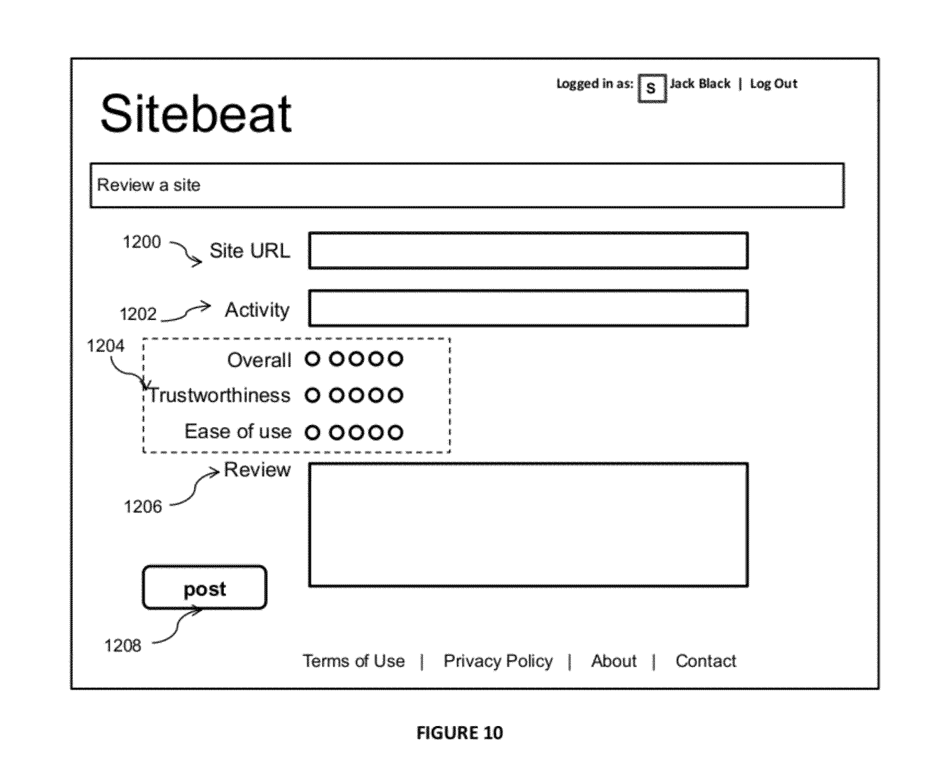

An exemplified review and rate page is shown in FIG. 10. A purpose of the review and rater page is to capture a review and ratings for a given website and activity. The review and rater page can have different variations depending on where the user enters the flow.

In one implementation, neither the website nor the activity is known. For example, the user can click the review button directly from the home page in which case both the activity and website have not been set. The page includes the following fields:

A website URL field 1200 captures the website address. The user may enter the full address such as www.sitename.com or a partial address such as sitename.com or just the sitename without the www or .com.

An activity field 1202 captures a string that defines an activity. The activity is typically specified as a verb followed by a noun combination such as, “Download music”, “Create a blog”, “Buy Shoes”, etc.

One or more websites default to 3 attributes 1204 (overall, trustworthiness, ease of use). The master list of attributes is stored in the attributes table 455 which is part of the core tables 322. An activity can include a set of attributes as shown in the examples below:

Activity 1: Overall; Trustworthiness; Ease of Use.

Activity 2: Overall; Trustworthiness; Ease of Use; Attribute 4—Example: Return Policy.

Activity 2: Overall; Trustworthiness; Ease of Use; Attribute 4 —Example: Return Policy; Attribute 5—Example: Product Quality; Attribute 6—Customer Service

Once the user is ready to submit the review the user may click on the post button 1208 to submit the review to the computer server system 120.

### The Profile Page

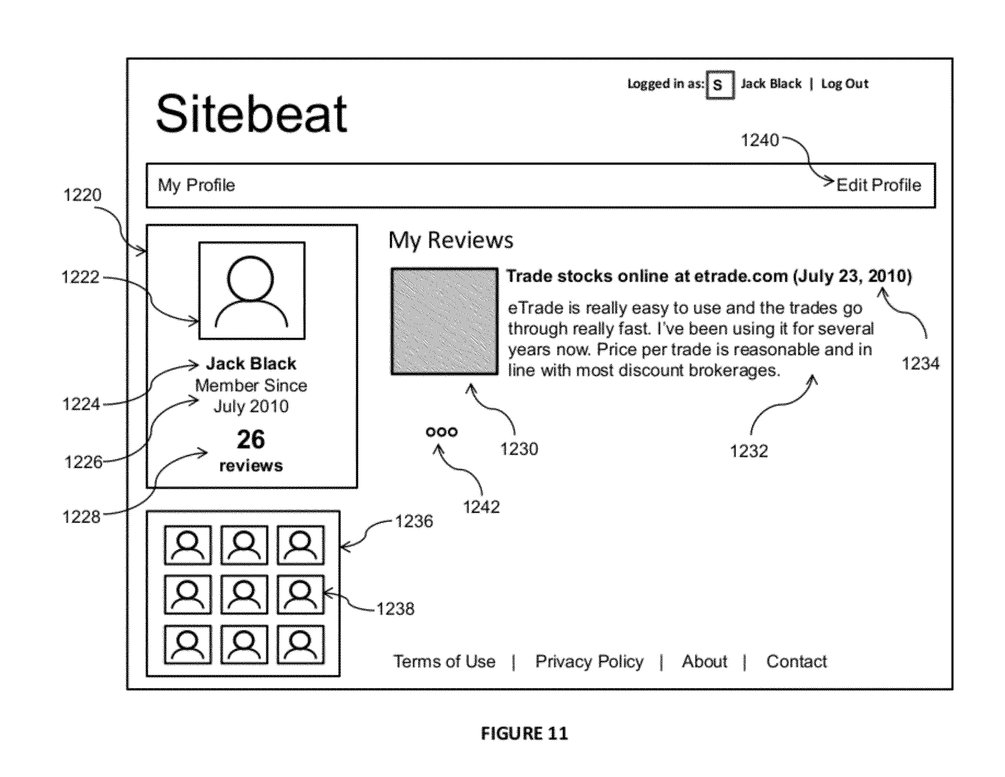

The profile page, referring to FIG. 11, can include a profile summary which can include: a profile picture 1222 for the user; the name of the user 1224; a membership 1226 about how long the user has been a member; credibility 1228 shows the number of reviews the user has added to the computer server system 120. The user information is stored in the user table 461 in the core tables 322 (FIG. 3). In some embodiments, the credibility 1128 may include how well the user's reviews were accepted by other users who read the reviews. This is captured in an option where the user who reads the review may indicate if they liked the review. Based on this feedback, the credibility of the reviewer may change. In a different embodiment, the credibility may also include the duration of membership and how recent is the last review.

A friends module 1236 displays friends of members pulled from the facebook, twitter and other social medial social graphs. The friends module 1236 can be used to post to the Facebook stream when members post a website to the computer server system 120, to search results may be filtered by websites that friends reviewed or rated, and to access friends profiles to see what websites they like.

The websites reviewed by the user are shown on the right pane. This enables the user to quickly assess a reviewed website. A user may be able to delete a website that he added. The websites reviewed include data such as a thumbnail of the website reviewed 1230, the activity and date 1234 and the actual review 1232.

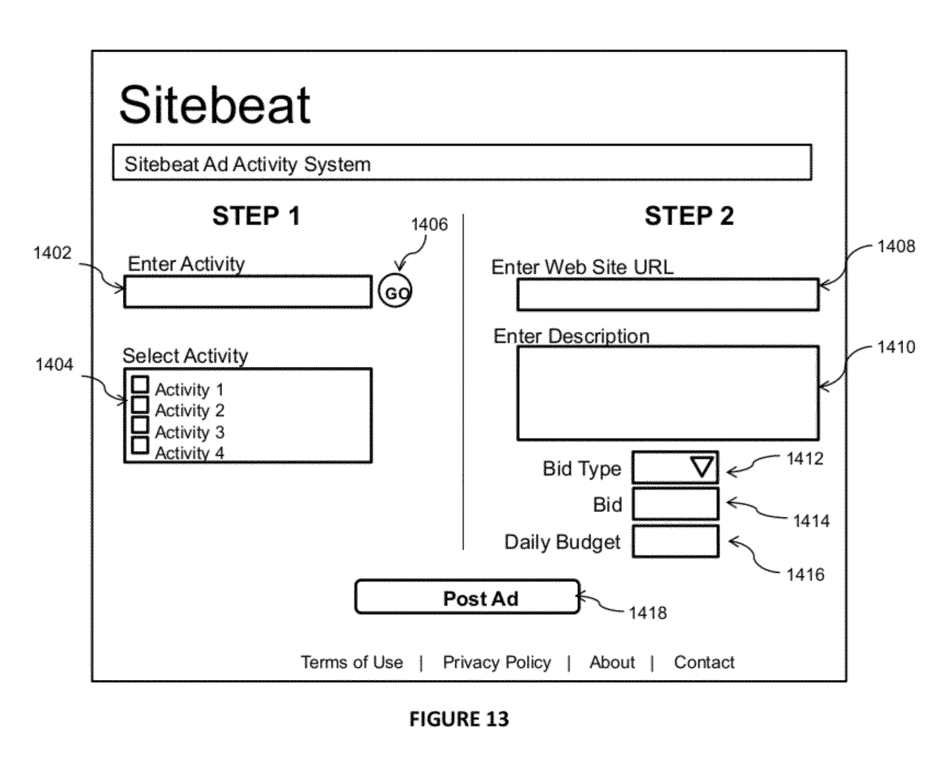

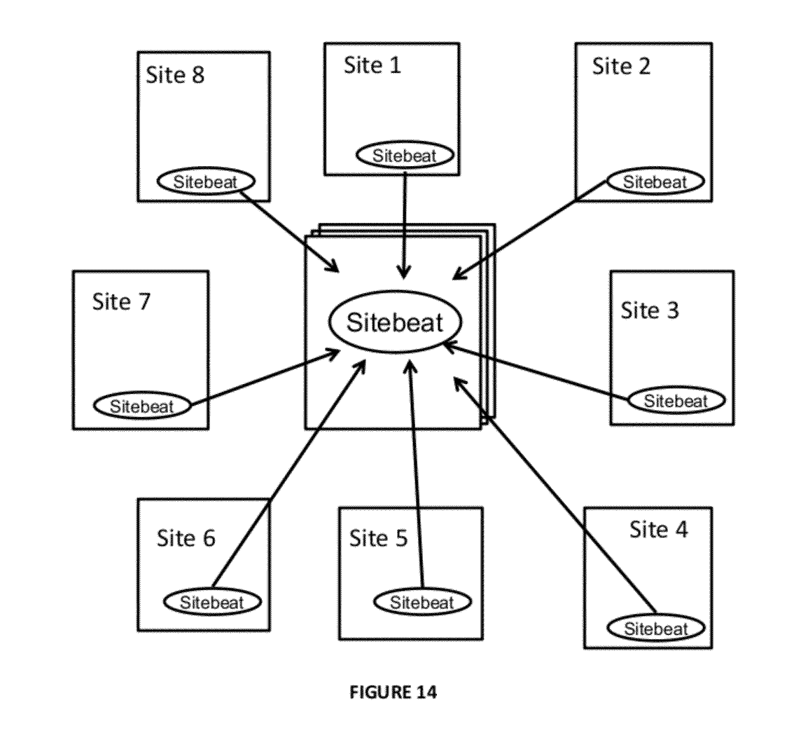

The disclosed system can provide a unique sponsorship model based on highly targeted activities that websites get mapped to. For example, the Site Ranking Page for an activity such as Rent a Car is specific to car renting only. Users who view this Site Ranking Page are strongly interested to rent a car. In another example, the Site Ranking Page may include websites to Trade online—again this is a highly targeted activity. As such, the real estate for advertisement Sponsorships is very valuable. Referring to FIG. 13, advertisers are provided with a simple mechanism to post an advertisement on the computer server system 120. The user interface can allows an advertiser to enter an activity name 1402. Once advertiser enters an activity and hits the GO button 1406, she is presented with a list of activities in a scrollable box 1404. The advertiser can pick one more activities that map to the query the user entered. In most cases, this may resolve to just one item and the user may pick one activity from by clicking on an item in the checkbox. The advertiser enters a URL 1408 to link the display advertisement to a website. This is the destination that the users end up at when they click on the advertisement in the computer server system 120. The advertiser can enter a description 1410 for the advertisement. Bid type is a drop down 1412 that specifies if it is a CPC (cost per click) or CPM (cost per impression) model. Bid 1414 specifies the dollar amount the sponsor is willing to pay for at least one click or impression. The bid amount feeds into the algorithm that controls the placement on the page. The daily budget 1416 provides a mechanism to cap the dollar amount spent per day.

### Sitebeat Seal

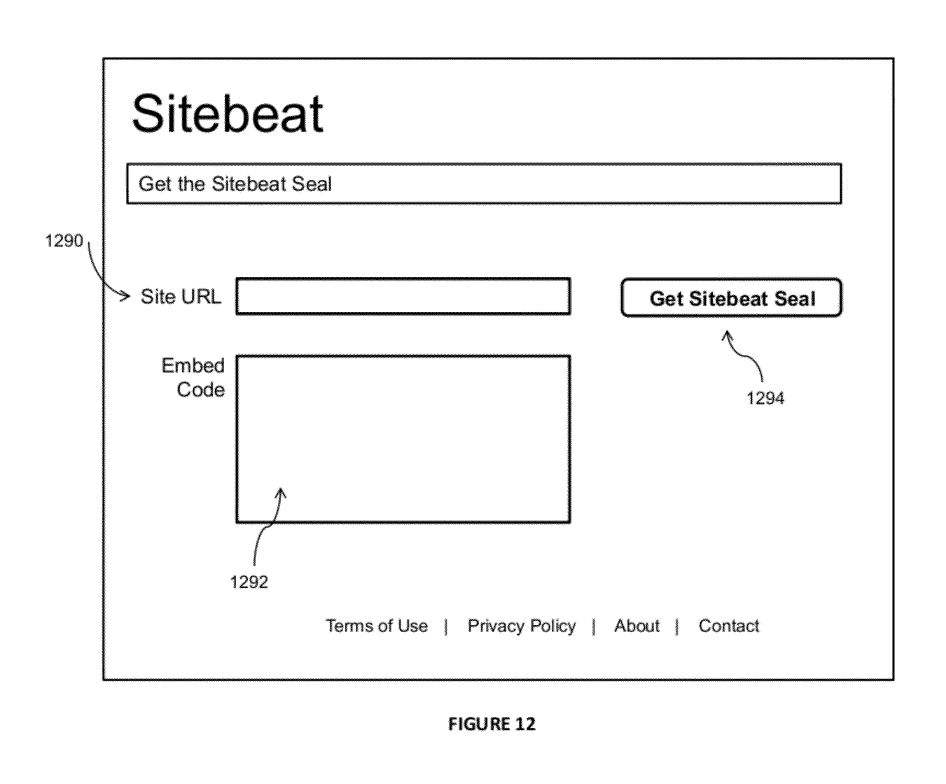

The Sitebeat Seal is method for third-party websites to provide unbiased testimonials on their website. The computer server system 120 provides a simple mechanism for website owners to obtain and install the Sitebeat Seal. In the embodiment shown in FIG. 12 the website owner would enter their site url in field 1290 and click the button 1294. The computer server system 120 would then return a code snippet into box 1292 that the website owner could include in their home page and thereby render the Sitebeat Seal on their home page.

FIG. 14 shows the adoption of Sitebeat seal across the Internet. The Sitebeat Seal can drive viral adoption of both Sitebeat and the Sitebeat Seal. Website owners who qualify to get the Sitebeat Seal can come to Sitebeat to get the seal that they may add to the footer or some other area of their website. FIG. 14 shows multiple websites that have added the Sitebeat seal. Customers who click on this seal on the third-party website may be taken to a web page on Sitebeat that has customer reviews and ratings for that particular website.

Various embodiments described or referenced herein may be configured or designed to provide various features, functionalities and/or other aspects such as one or more of the following: A system, method and/or computer program product for collecting reviews and ratings for any website. System, method and/or computer program product for collecting reviews and ratings for any website where the ratings may be across multiple attributes. System, method and/or computer program product for collecting reviews and ratings for any website, where at least one website may be mapped to a different set of variables based on the activity the website supports. A system, method and/or computer program product to view reviewed and rate websites. A system, method and/or computer program product where the reviewed websites are mapped to a specific user context through an activity. A system, method and/or computer program product where the reviewed websites are mapped to a specific user context through an activity which may be performed from any device (laptop, desktop, iPad, iPhone, and other smart phones). A system, method and/or computer program product that provides multiple views to view reviewed and rated websites (gridview, ratings view). A system, method and/or computer program product to assign context through an activity for any website—example download music, rent a movie, buy a shirt. A system, method and/or computer program product to assign multiple contexts to a given website based on activity—example Amazon: Activity 1=Buy Shoes, Amazon: Activity 2=Buy Books. A system, method and/or computer program product to get the credibility of a website A system, method and/or computer program product to provide independent customer testimonials for any website where the website adds a Sitebeat Seal to the footer of their website to access the testimonials. A method is closed to see activities for any website. A system, method and/or computer program product for sponsors advertise on highly targeted pages by providing sponsors a context through the activity. A method is closed to see the rating of a website directly from the browser from a toolbar application. A method is closed to rate and review a website directly from the browser from a toolbar application. A method is closed to navigate to similar websites dynamically as the user is browsing from website to website. A system, method and/or computer program product entrepreneurs to set up highly targeted start pages or landing pages that may serve advertisements. At least one page has relevant modules including reviewed and rates websites. A system, method and/or computer program product for companies to measure the voice of their customers relative to peers through the reviews and ratings of websites.

Although several example embodiments of one or more aspects and/or features have been described in detail herein with reference to the accompanying drawings, it is to be understood that aspects and/or features are not limited to these precise embodiments, and that various changes and modifications may be effected therein by one skilled in the art without departing from the scope of spirit of the invention(s) as defined, for example, in the appended claims.

What is claimed is:

1. A computer-implemented method for helping users to find the most relevant website for a given activity, comprising:
storing, in an activity database, a plurality of activities each comprising a verb that represents a task associated with the activity;
storing, in the activity database, addresses of a plurality of websites in association with activities respectively identified in each of the plurality of websites;
receiving a query from a first user by a computer server system in communication with the activity database;
identifying a first activity pertaining to the query by the computer server system; and
returning to the first user, addresses of one or more websites associated with the first activity, wherein the one or more websites are stored in the activity database.

2. The computer-implemented method of claim 1, wherein each of the plurality of activities stored in the activity database includes a phrase commencing with a verb.

3. The computer-implemented method of claim 2, wherein the phrase includes an object after the verb.

4. The computer-implemented method of claim 2, wherein the phrase includes a word about a location.

5. The computer-implemented method of claim 1, further comprising:
identifying a first set of activities pertaining to the query by a computer server system;
receiving a selection of the first activity by the first user from the first set of activities; and
returning by the computer server system, to the first user, addresses of one or more websites associated with the first activity, wherein the one or more websites are stored in the activity database.

6. The computer-implemented method of claim 1, further comprising:
storing, in the activity database, a rank value relative to the first activity for each of the plurality of websites that is identified to include the first activity; and
returning, to the first user, addresses of the one or more websites in an order based on the rank values of the one or more websites relative to the first activity.

7. The computer-implemented method of claim 6, further comprising:
receiving, from a second user, a rank value relative to the first activity for at least one of the plurality of websites that is identified to include the first activity.

8. The computer-implemented method of claim 6, further comprising:
receiving, from a second user, a review relative to the first activity for one of the plurality of websites that is identified to include the first activity.

9. The computer-implemented method of claim 8, further comprising:
storing a credibility value about the second user in the activity database, wherein the credibility value reflects the number of reviews for the plurality of websites that the second user has reviewed for the computer server system.

10. The computer-implemented method of claim 8, further comprising:
allowing the one of the plurality of websites to display a graphical seal on a webpage at the website; and
providing a web link from the graphical seal to the review by the second user about the one of the plurality of websites.

11. The computer-implemented method of claim 1, further comprising:
allowing a second user to create a first website and to map the first website to a first activity; and
allowing the first user to view the first website after receiving the query from the first user.

12. The computer-implemented method of claim 1, wherein the step of identifying a first activity in the query comprises identifying, in the query, one or more verbs associated with the one or more activities.

13. The computer-implemented method of claim 1, wherein the query comprises a text string TS, wherein the step of identifying a first activity pertaining to the query by the computer server system comprises:
returning the first activity stored in the activity database to the first user, wherein the first activity exactly matches TS, or the first activity includes each word in (TS-s), wherein is one or more small words, or the first activity includes each word in (TS-s-v), wherein v is one or more verbs, or the first activity includes each word in (TS-s-v-a), wherein a is one or more adjectives and adverbs, or the first activity includes each word in (TS-s-v-a-nv), wherein v is one or more noun-verbs, or the first activity includes the largest number of words in (TS-s-v-a-nv).

14. The computer-implemented method of claim 1, wherein the query comprises a first word, wherein the step of identifying a first activity pertaining to the query by the computer server system comprises:
identifying a group of words associated with the first word; and
identifying the first activity based on the association between the first activity and at least one word in the group of words.

15. The computer-implemented method of claim 1, further comprising:
grouping multiple related activities in the plurality of activities stored in the activity database in a category, wherein the multiple related activities include the first activity;
presenting the multiple activities in the category to the first user;
receiving a selection of at least one of the multiple activities in the category by the first user; and
returning, to the first user, addresses of one or more websites associated with the at least one of the multiple activities in the category.

16. A computer-implemented method for helping users to find the most relevant website for a given activity, comprising:
storing, in an activity database, a plurality of activities each representing a task associated with the activity;
storing, in the activity database, addresses of a plurality of websites in association with activities respectively identified in each of the plurality of websites;
storing, in the activity database, a rank value relative to the first activity for each of the plurality of websites that is identified to include the first activity;
receiving a query from a first user by a computer server system in communication with the activity database;
identifying a first activity pertaining to the query by the computer server system; and
returning to the first user, addresses of one or more websites associated with the first activity in an order based on the rank values of the one or more websites relative to the first activity, wherein the one or more websites are stored in the activity database.

17. The computer-implemented method of claim 16, wherein each of the plurality of activities stored in the activity database includes a phrase commencing with a verb, wherein the phrase represents the task associated with the activity.

18. The computer-implemented method of claim 16, further comprising:
receiving, from a second user, a rank value relative to the first activity for at least one of the plurality of websites that is identified to include the first activity.

19. A computer-implemented method for helping users to find the most relevant website for a given activity, comprising:
storing, in an activity database, a plurality of activities each comprising a verb that represents a task associated with the activity;
storing, in the activity database, addresses of a plurality of websites in association with activities respectively identified in each of the plurality of websites;
allowing a first user to create a first website and to map the first website to a first activity;
receiving a query from a second user by a computer server system in communication with the activity database;
identifying the first activity pertaining to the query by the computer server system; and
returning to the second user, at least the address of the first website mapped to the first activity, which allows the second user to view the first website.

20. The computer-implemented method of claim 16, wherein each of the plurality of activities stored in the activity database includes a phrase commencing with a verb, wherein the phrase represents the task associated with the activity.
